(19) United States
(12) Patent Application Publication
(10) Pub. No.: US 2026/0369781 A1
(43) Pub. Date: Nov. 19, 2026

(54) BATTERY PACK AND POWER TOOL COMBINATION

(71) Applicant: JIANGSU DONGCHENG M&E TOOLS CO., LTD., NANTONG (CN)

(72) Inventors: FENG JIANG, NANTONG (CN); XINGXING HUANG, NANTONG (CN); HONG JI, NANTONG (CN)

(21) Appl. No.: 19/724,915

(22) Filed: Jun. 30, 2026

Related U.S. Application Data
(63) Continuation of application No. PCT/CN2025/131757, filed on Oct. 31, 2025.

(30) Foreign Application Priority Data
Nov. 28, 2024 (CN) 202411728688.5

(51) Int. Cl. H01M 50/247; B25F 5/00; H01M 10/42; H01M 50/213; H01M 50/262; H01M 50/269; H01M 50/296; H01M 50/507; H01M 50/51

(52) U.S. Cl. CPC H01M 50/247; B25F 5/00; H01M 10/425; H01M 50/213; H01M 50/262; H01M 50/269; H01M 50/296; H01M 50/507; H01M 50/51; H01M 2220/30

(57) ABSTRACT

Provided are a battery pack and a power tool combination. The battery pack includes a housing, a cell assembly, a control assembly, and a terminal assembly. The terminal assembly includes a total positive output terminal and a total negative output terminal. The cell assembly includes a first cell group and a second cell group. The first cell group has a first positive output terminal and a first negative output terminal, and the second cell group has a second positive output terminal and a second negative output terminal. The battery pack includes a voltage transformation assembly for switching an output voltage of the cell assembly. The voltage transformation assembly includes a movably arranged switching element and a plurality of connecting pieces respectively connected to the above output terminals.

### CROSS REFERENCE TO RELATED APPLICATIONS

The present application is a continuation of PCT Patent Application No. PCT/CN2025/131757, entitled “BATTERY PACK AND POWER TOOL COMBINATION,” filed Oct. 31, 2025, which claims priority to Chinese patent application No. 202411728688.5, entitled “BATTERY PACK AND POWER TOOL COMBINATION,” filed Nov. 28, 2024, each of which is incorporated by reference herein in its entirety.

### TECHNICAL FIELD

The present disclosure relates to the technical field of power tools, and in particular, to a battery pack and a power tool combination having the battery pack.

### BACKGROUND

A power tool is an apparatus in which a motor drives a working head to operate to perform operations such as grinding, cutting, polishing, and fastening on a workpiece. Traditional power tools are powered by 220V alternating current (AC) mains. However, with the rapid development of lithium batteries, lithium battery-powered power tools, which are powered by battery packs, have gradually replaced traditional AC-powered power tools.

A plurality of cells are usually provided inside a battery pack to output voltage to the outside. In order to cope with usage scenarios of different powers and working conditions, battery packs for lithium battery-powered power tools have also evolved into a variety of different voltages, such as common 20V platform battery packs and 40V platform battery packs. For a user, the user needs to purchase multiple battery packs of different platforms, resulting in an increase in cost. During operation, the user also has to carry multiple battery packs at the same time and switch between the multiple battery packs, which affects work efficiency and makes the user experience poor.

In view of this, there is indeed a need to provide an improved battery pack and power tool combination to overcome the defects existing in the existing art.

### SUMMARY

In view of the deficiencies in the prior art, an object of the present disclosure is to provide a battery pack capable of outputting different voltages and a power tool combination.

The present disclosure solves the problems of the prior art by adopting the technical solutions below. A battery pack is provided, including a housing, a cell assembly, a control assembly, a terminal assembly, and a voltage transformation assembly.

The cell assembly is mounted in the housing and includes a first cell group and a second cell group connected to each other, where the first cell group has a first positive output terminal and a first negative output terminal, and the second cell group has a second positive output terminal and a second negative output terminal. The control assembly is connected to the cell assembly. The terminal assembly is connected to the control assembly and includes a total positive output terminal and a total negative output terminal configured to output power of the cell assembly to outside. The voltage transformation assembly is configured to switch an output voltage of the cell assembly and includes a plurality of connecting pieces and a switching element. The plurality of connecting pieces are connected to the total positive output terminal, the second positive output terminal, the first negative output terminal and the total negative output terminal. The switching element is movably arranged relative to the plurality of connecting pieces and configured to move to different positions to change an electrical connection relationship among the plurality of connecting pieces so that the battery pack switches its output voltage between a high voltage and a low voltage, a voltage value of the high voltage being larger than a voltage value of the low voltage.

When the battery pack outputs the high voltage, the first cell group and the second cell group are connected in series, and when the battery pack outputs the low voltage, the first cell group and the second cell group are connected in parallel.

As an improvement, the plurality of connecting pieces include a first connecting piece, connected to the total positive output terminal, a second connecting piece connected to the second positive output terminal, a third connecting piece connected to the first negative output terminal, a fourth connecting piece connected to the total negative output terminal, and an intermediate connecting piece. When the battery pack outputs the high voltage, the second connecting piece is electrically connected to the third connecting piece via the intermediate connecting piece, and when the battery pack outputs the low voltage, the first connecting piece is electrically connected to the second connecting piece, and the third connecting piece is electrically connected to the fourth connecting piece.

As an improvement, the voltage transformation assembly further includes a box body and a moving element. The plurality of connecting pieces are all fixed to the box body. The moving element is movably connected to the box body, connected to the switching element, and configured to drive, when moved, the switching element to move so as to achieve switching between the high voltage and the low voltage.

As an improvement, the moving element includes a base body, a rod body and a head part. The base body is configured to mount the switching element. The rod body is connected to the base body. The head part is connected to the rod body. The base body and the head part are located on two sides of the rod body, the housing has a through opening, and the head part is exposed outside the battery pack via the opening.

As an improvement, the box body has a first box shell and a second box shell connected to each other, the first box shell has a guide groove configured to mount the rod body and a passage penetrating the guide groove, and the rod body is inserted through the passage.

As an improvement, the voltage transformation assembly further includes a first elastic member biasing the moving element. The head part has a first positioning portion for mounting the first elastic member, the first box shell has a second positioning portion protruding from an end surface, and the first elastic member is connected between the first positioning portion and the second positioning portion.

As an improvement, the rod body includes a guide pillar, and an avoidance groove. The guide pillar protrudes toward the first elastic member. The avoidance groove is recessed from an end surface of the guide pillar, where the first elastic member is inserted through the avoidance groove.

As an improvement, the switching element includes a main body portion, and a pair of contacts. The pair of contacts extend from the main body portion toward the plurality of connecting pieces, and are configured to connect any two of the plurality of connecting pieces.

As an improvement, the base body includes a pair of clamping arms, and a movable groove. The pair of clamping arms are arranged at an interval. The movable groove is located between the pair of clamping arms, where the main body portion is accommodated in the movable groove.

As an improvement, the base body further includes a positioning groove. The positioning groove is recessed from an end surface of a respective clamping arm. The switching element further includes a wing portion extending from the main body portion toward the base body. The voltage transformation assembly further includes a second elastic member biasing the switching element, one end of the second elastic member is accommodated in the positioning groove, and another end of the second elastic member is sleeved on the wing portion.

As an improvement, the switching element further includes a guide portion extending from the main body portion toward the base body, located between a pair of wing portions, and extending into the movable groove. A length of the guide portion extending toward the base body is greater than a length of each of the pair of wing portions extending toward the base body.

As an improvement, each of the first connecting piece, the second connecting piece, the third connecting piece, and the fourth connecting piece includes a first contact portion accommodated in the box body, a second contact portion exposed outside the box body, and a connection port penetrating the second contact portion. The switching element is connected to the first contact portion, and the total positive output terminal, the second positive output terminal, the first negative output terminal, and the total negative output terminal are respectively connected to the plurality of connecting pieces via connection ports.

As an improvement, the box body is provided with a gas hole at a mounting area corresponding to the first contact portion, and the gas hole communicates an interior of the box body with an exterior of the box body.

As an improvement, the first connecting piece is located between the second connecting piece and the intermediate connecting piece, the fourth connecting piece is located between the third connecting piece and the intermediate connecting piece, and the intermediate connecting piece straddles the first connecting piece and the fourth connecting piece.

As an improvement, the main body portion has an extension axis, and a projection of the extension axis on the plurality of connecting pieces simultaneously passes through the first connecting piece, the second connecting piece, and the intermediate connecting piece, or simultaneously passes through the fourth connecting piece, the third connecting piece, and the intermediate connecting piece.

As an improvement, a connection strap is disposed between the total positive output terminal and the first connecting piece, and another connection strap is disposed between the total negative output terminal and the fourth connecting piece.

As an improvement, a plurality of switching elements are provided, and include a first group of switching elements configured to change a connection relationship among the first connecting piece, the second connecting piece, and the intermediate connecting piece, and a second group of switching elements configured to change a connection relationship among the fourth connecting piece, the third connecting piece, and the intermediate connecting piece. Each of the first group of switching elements and the second group of switching elements has at least two switching elements.

As an improvement, the first cell group and the second cell group are each formed by a plurality of cells connected in series, and a voltage value of each cell in the first cell group and the second cell group is the same.

As an improvement, the cell assembly further includes a cell bracket configured to mount the first cell group and the second cell group, and connected to the voltage transformation assembly. The cell bracket includes a first limiting portion, a second limiting portion, and a pair of claws. The first limiting portion and the second limiting portion respectively support two opposing ends of a box body of the voltage transformation assembly. The pair of claws are configured to fasten the box body and located between the first limiting portion and the second limiting portion.

As an improvement, the cell assembly has a cell bracket including a partition plate. The partition plate protrudes from an end surface of the cell bracket, where at least a part of the partition plate is located between the first connecting piece and the second connecting piece, and at least another part of the partition plate is located between the fourth connecting piece and the third connecting piece.

The present disclosure may also solve the problems of the prior art by adopting the technical solutions below. A power tool combination is provided, including a power tool and the battery pack described above. The power tool includes a housing, a drive assembly mounted in the housing, and an output head connected to the drive assembly. The battery pack is connected to the power tool and configured to provide energy for the drive assembly. The housing includes a battery pack mounting seat configured to mount the battery pack and having a first type mounting seat and a second type mounting seat with different structures. The battery pack is configured to output the high voltage when the power tool is assembled with the first type mounting seat, and to output the low voltage when the power tool is assembled with the second type mounting seat.

As an improvement, the first type mounting seat has a recessed slot, a position of the slot corresponds to a position of an opening of the housing, and when the battery pack is mounted to the first type mounting seat, the moving element of the voltage transformation assembly passes through the opening and extends into the slot. The second type mounting seat is provided with an abutting portion at the position corresponding to the opening, and when the battery pack is mounted to the second type mounting seat, the abutting portion drives the moving element to move so that the battery pack switches from the high voltage to the low voltage.

Compared with the existing art, the present disclosure has the following beneficial effects: by designing a battery pack with a variable output voltage, a user does not need to prepare multiple battery packs, which is beneficial to improving operational convenience and work efficiency of the user. In addition, a differentiated design is made for the battery pack mounting seat of the power tool, and the power tool selects a high voltage input or a low voltage input according to the needs of the usage occasion, and further selects the first type mounting seat or the second type mounting seat, while the battery pack is not limited and is universally mounted to the first type mounting seat or the second type mounting seat, effectively constructing a power tool combination with low cost and good user experience; in addition, when the battery pack is mounted to the power tool, the output voltage of the battery pack is automatically switched, and the operation is simpler.

### BRIEF DESCRIPTION OF THE DRAWINGS

FIG. 1 is an overall schematic diagram of a battery pack according to a first embodiment of the present disclosure, when the battery pack outputs a high voltage.

FIG. 2 is an overall schematic diagram of the battery pack shown in FIG. 1 outputting a low voltage.

FIG. 3 is an exploded schematic diagram of the battery pack shown in FIG. 1.

FIG. 4 is a structural schematic diagram of a cell assembly, a control assembly, a terminal assembly, and a voltage transformation assembly in the battery pack shown in FIG. 1 from a first angle.

FIG. 5 is an exploded schematic diagram of the cell assembly, the control assembly, the terminal assembly, and the voltage transformation assembly shown in FIG. 4.

FIG. 6 is a structural schematic diagram of the cell assembly, the control assembly, the terminal assembly, and the voltage transformation assembly shown in FIG. 4 from a second angle.

FIG. 7 is a structural schematic diagram of the cell assembly, the control assembly, the terminal assembly, and the voltage transformation assembly shown in FIG. 4 from a third angle.

FIG. 8 is a schematic diagram of an internal structure of the control assembly shown in FIG. 7.

FIG. 9 is an exploded schematic diagram of the voltage transformation assembly in the battery pack shown in FIG. 1.

FIG. 10 is a connection schematic diagram of the voltage transformation assembly, the cell assembly, and the terminal assembly in the battery pack shown in FIG. 1, when the battery pack outputs the high voltage.

FIG. 11 is a connection schematic diagram of the voltage transformation assembly, the cell assembly, and the terminal assembly in the battery pack shown in FIG. 1, when the battery pack outputs the low voltage.

FIG. 12 is a schematic diagram of an internal structure of the voltage transformation assembly shown in FIG. 9.

FIG. 13 is a structural schematic diagram of a switching element in the voltage transformation assembly shown in FIG. 9.

FIG. 14 is a structural schematic diagram of a power tool combination of the present disclosure.

FIG. 15 is a structural schematic diagram of a first type mounting seat in the power tool combination shown in FIG. 14.

FIG. 16 is a structural schematic diagram of a second type mounting seat in the power tool combination shown in FIG. 14.

FIG. 17 is an overall schematic diagram of a battery pack according to a second embodiment of the present disclosure, when the battery pack outputs the high voltage.

FIG. 18 is an overall schematic diagram of the battery pack shown in FIG. 17 outputting the low voltage.

FIG. 19 is an exploded schematic diagram of the battery pack shown in FIG. 17.

FIG. 20 is a structural schematic diagram of a cell assembly, a control assembly, a terminal assembly, and a voltage transformation assembly in the battery pack shown in FIG. 19 from a first angle.

FIG. 21 is a structural schematic diagram of the cell assembly, the control assembly, the terminal assembly, and the voltage transformation assembly in the battery pack shown in FIG. 19 from a second angle.

FIG. 22 is a structural schematic diagram of the cell assembly, the control assembly, the terminal assembly, and the voltage transformation assembly in the battery pack shown in FIG. 19 from a third angle.

FIG. 23 is a structural schematic diagram of the cell assembly, the control assembly, the terminal assembly, and the voltage transformation assembly in the battery pack shown in FIG. 19 from a fourth angle.

FIG. 24 is an exploded schematic diagram of the voltage transformation assembly in the battery pack shown in FIG. 19.

### DETAILED DESCRIPTION OF THE EMBODIMENTS

The specific embodiments of the present disclosure are described in further detail below with reference to the accompanying drawings.

Terms used in the present disclosure are only for the purpose of describing specific embodiments and are not intended to limit the present disclosure. For example, the following words indicating orientation or positional relationships, such as “upper,” “lower,” “front,” and “rear,” are only based on the orientation or positional relationships shown in the drawings, merely for the convenience of describing the present disclosure and simplifying the description, rather than indicating or implying that the referred apparatus/element must have a specific orientation or be constructed and operated in a specific orientation, and therefore should not be construed as a limitation on the present disclosure.

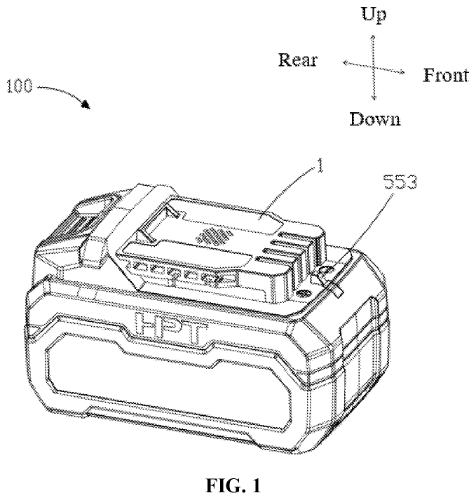

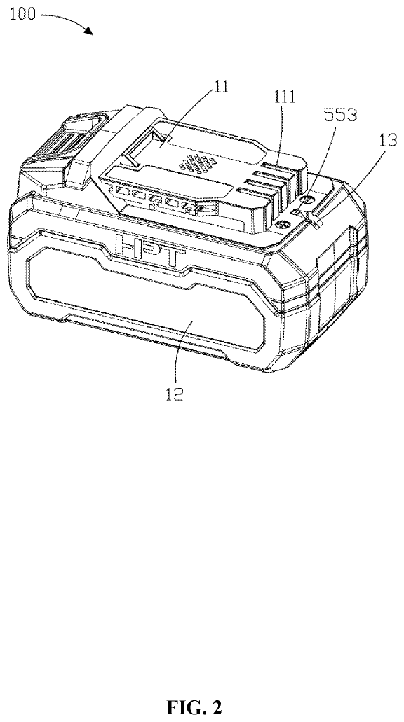

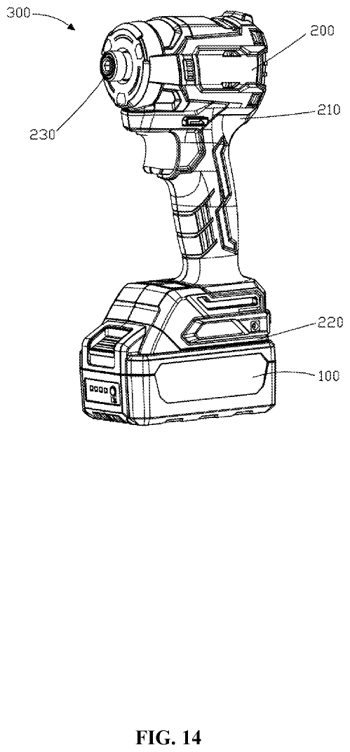

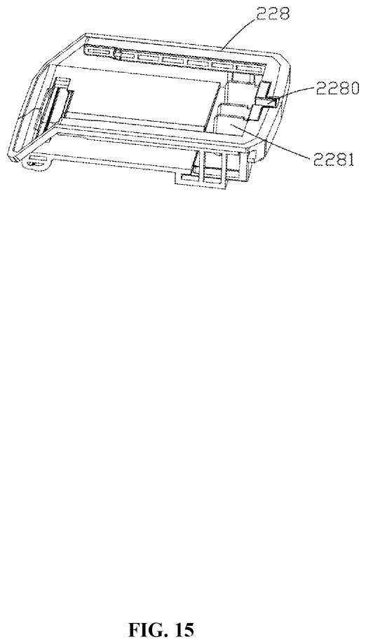

Referring to FIG. 1, FIG. 2, and FIG. 14 to FIG. 16, a first embodiment of the present disclosure relates to a power tool combination 300, including a power tool 200 and a battery pack 100 connected to each other, where the battery pack 100 is coupled to the power tool 200 and configured to supply power to the power tool 200. Further, the power tool 200 may be a traditional power tool such as an electric drill, an electric wrench, an electric hammer, an angle grinder, a cutting machine, and a sander, and may also be a gardening power tool such as a blower, a chain saw, a grass trimmer, a lawn mower, and a hedge trimmer. In the present embodiment, the power tool 200 is an electric wrench, and includes a casing 210, a drive assembly (not shown) mounted in the casing 210, an output head 230 connected to the drive assembly, and the battery pack 100 providing energy for the drive assembly. The casing 210 includes a battery pack mounting seat 220 for mounting the battery pack 100. Tool terminals 2281, 2291 corresponding to the battery pack 100 are provided on the battery pack mounting seat 220, and power of the battery pack 100 is transmitted to the drive assembly via the tool terminals 2281, 2291, thereby driving the output head 230 to operate.

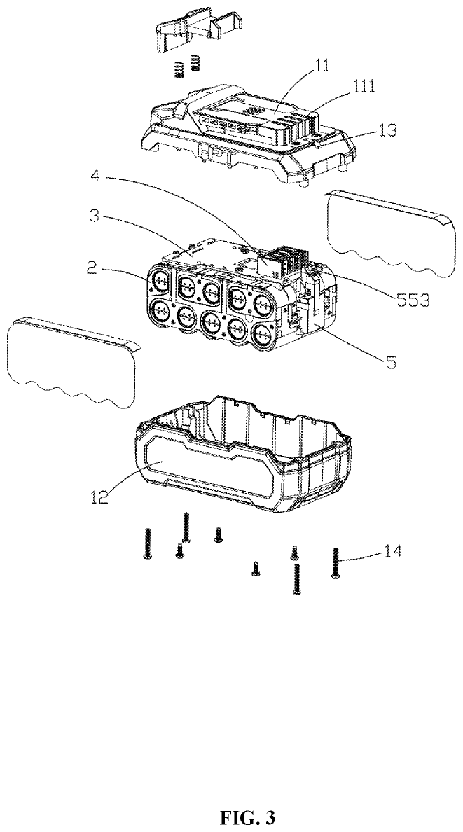

Referring to FIG. 3, the above battery pack 100 includes a housing 1, a cell assembly 2 mounted in the housing 1, a control assembly 3 connected to an upper side of the cell assembly 2, a terminal assembly 4 connected to the control assembly 3, and a voltage transformation assembly 5 configured to switch an output voltage of the cell assembly 2. The tool terminals 2281, 2291 are electrically connected to the terminal assembly 4. The terminal assembly 4 is configured to output the power of the cell assembly 2 to the power tool 200. The housing 1 includes an upper housing 11 and a lower housing 12 connected to each other, and screws 14 are inserted through the upper housing 11 and the lower housing 12 to fix the upper housing 11 and the lower housing 12. Further, the upper housing 11 and the lower housing 12 are closed together to form a closed space, and the cell assembly 2, the control assembly 3, the terminal assembly 4, and the voltage transformation assembly 5 are all accommodated in the closed space.

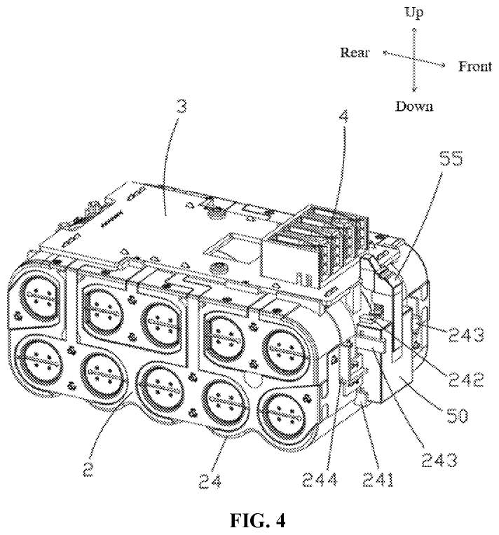

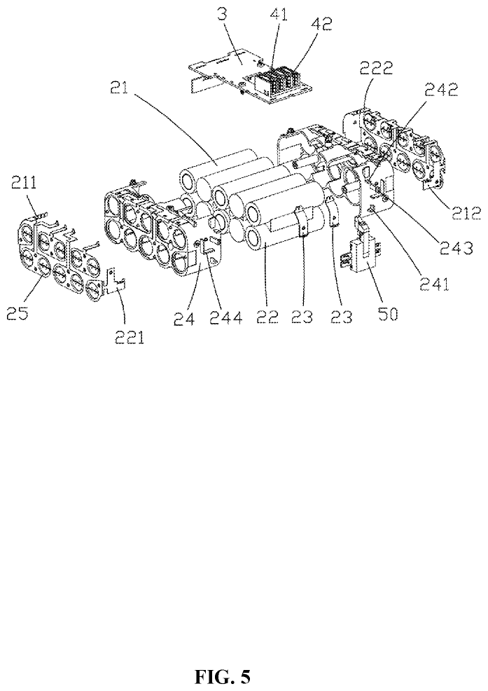

Referring to FIG. 4 and FIG. 5, the above cell assembly 2 includes a first cell group 21 and a second cell group 22 connected to each other, and a cell bracket 24 for mounting the first cell group 21 and the second cell group 22. The first cell group 21 and the second cell group 22 are each formed by a plurality of cylindrical cells connected in series, and a voltage value of each cell in the two cell groups is the same. In the present embodiment, the first cell group 21 and the second cell group 22 are each formed by 5 cells connected in series, and two adjacent cells are electrically connected to each other via a conductive sheet 25. A nominal voltage of each cell is 4V, so the first cell group 21 and the second cell group 22 both have an output voltage of 20V.

In the present embodiment, the first cell group 21 has a first positive output terminal 211 and a first negative output terminal 212, and the second cell group 22 has a second positive output terminal 221 and a second negative output terminal 222.

In the present embodiment, the terminal assembly 4 includes a total positive output terminal 41 and a total negative output terminal 42 for outputting the power of the cell assembly 2 to the outside. The total positive output terminal 41 and the total negative output terminal 42 are connected to the tool terminals of the power tool 200 and transmit the power of the cell assembly 2 to the power tool 200. Further, the terminal assembly 4 is mounted on a top surface of the control assembly 3. The upper housing 11 is provided with openings 111 corresponding to the total positive output terminal 41 and the total negative output terminal 42, and the total positive output terminal 41 and the total negative output terminal 42 extend into the openings 111.

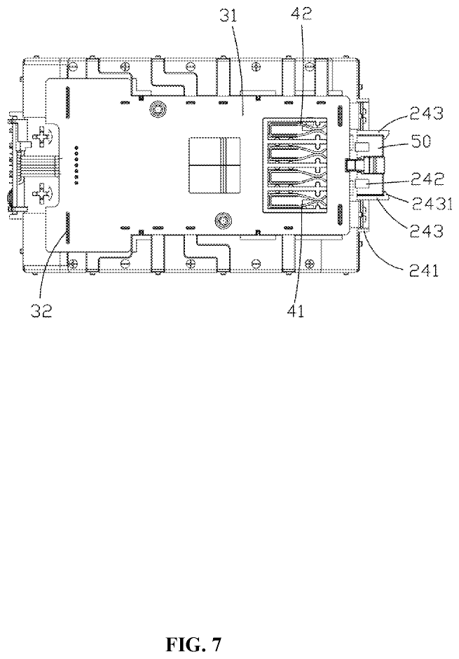

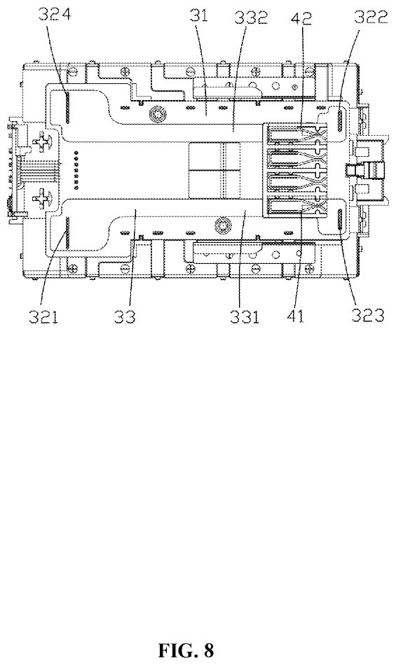

Referring to FIG. 7 and FIG. 8, the above control assembly 3 is mounted on the top surface of the cell assembly 2. The control assembly 3 includes a plate-shaped controller main body 31, conductive ports 32 penetrating the controller main body 31, and conductive straps 33 provided on the controller main body 31. The conductive straps 33 connect the cell assembly 2 and the terminal assembly 4 and are configured to realize conductive connection between the cell assembly 2 and the terminal assembly 4.

In the present embodiment, the above conductive ports 32 include a first conductive port 321 connected to the first positive output terminal 211, a second conductive port 322 connected to the first negative output terminal 212, a third conductive port 323 connected to the second positive output terminal 221, and a fourth conductive port 324 connected to the second negative output terminal 222. The conductive straps 33 include a first conductive strap 331 connecting the first conductive port 321 and the third conductive port 323, and a second conductive strap 332 connecting the second conductive port 322 and the fourth conductive port 324. The total positive output terminal 41 is connected to the first conductive strap 331, and is located between the first conductive port 321 and the third conductive port 323. The total negative output terminal 42 is connected to the second conductive strap 332, and is located between the second conductive port 322 and the fourth conductive port 324.

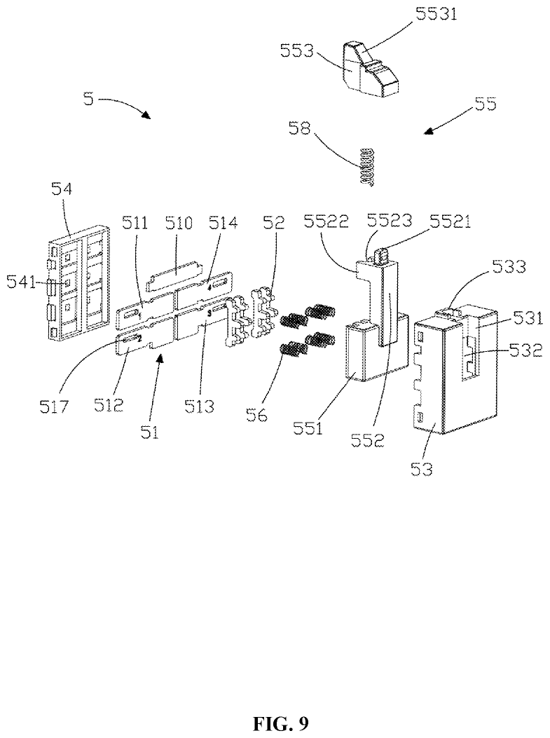

Referring to FIG. 3 and FIG. 9, the above voltage transformation assembly 5 includes a box body 50 connected to the cell assembly 2, a plurality of connecting pieces 51 respectively connected to the above output terminals, a moving element 55 movably connected to the box body 50, and a switching element 52 connected to the moving element 55. The plurality of connecting pieces 51 are electrically connected to the cell assembly 2, and the switching element 52 of the voltage transformation assembly 5 is connected to the connecting pieces 51. The switching element 52 is configured to change an electrical connection relationship among the plurality of connecting pieces 51, thereby changing an electrical connection relationship between the first cell group 21 and the second cell group 22, and enabling the battery pack 100 to switches its output voltage between a high voltage and a low voltage of different voltage values.

By designing a battery pack 100 with a variable output voltage, a user does not need to prepare multiple battery packs, which is beneficial to improving operational convenience and work efficiency of the user.

Further, when the battery pack 100 outputs the high voltage, the first cell group 21 and the second cell group 22 are connected in series; and when the battery pack 100 outputs the low voltage, the first cell group 21 and the second cell group 22 are connected in parallel.

Still further, the plurality of connecting pieces 51 are all fixed to the box body 50, and movement of the moving element 55 drives the switching element 52 to move so as to switch between the high voltage and the low voltage.

In the present embodiment, the above connecting pieces 51 include a first connecting piece 511 connected to the total positive output terminal 41, a second connecting piece 512 connected to the second positive output terminal 221, a third connecting piece 513 connected to the first negative output terminal 212, a fourth connecting piece 514 connected to the total negative output terminal 42, and an intermediate connecting piece 510. Correspondingly, a plurality of switching elements 52 are provided, and include a first group of switching elements 528 for changing a connection relationship among the first connecting piece 511, the second connecting piece 512, and the intermediate connecting piece 510, and a second group of switching elements 529 for changing a connection relationship among the fourth connecting piece 514, the third connecting piece 513, and the intermediate connecting piece 510.

The working principle of the battery pack 100 is as follows.

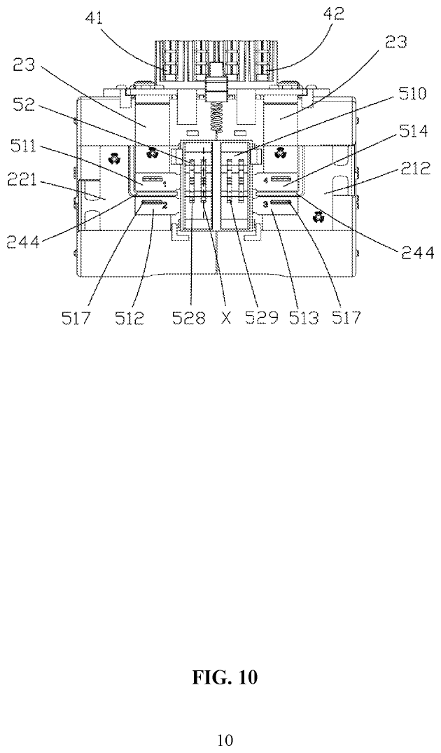

Referring to FIG. 10, when the battery pack 100 outputs the high voltage, the first group of switching elements 528 is electrically connected between the second connecting piece 512 and the intermediate connecting piece 510, and the second group of switching elements 529 is electrically connected between the third connecting piece 513 and the intermediate connecting piece 510, so that the second connecting piece 512 and the third connecting piece 513 are electrically connected to each other via the common intermediate connecting piece 510, so as to connect the first negative output terminal 212 of the first cell group 21 to the second positive output terminal 221 of the second cell group 22, thereby realizing a series connection of the first cell group 21 and the second cell group 22. In addition, the first positive output terminal 211 is connected to the total positive output terminal 41, and the second negative output terminal 222 is connected to the total negative output terminal 42. At this time, the battery pack 100 outputs a high voltage of 40V to the outside.

Further, when the battery pack 100 outputs the high voltage, there is no electrical conduction between the first connecting piece 511 and the total positive output terminal 41, and there is no electrical conduction between the fourth connecting piece 514 and the total negative output terminal 42.

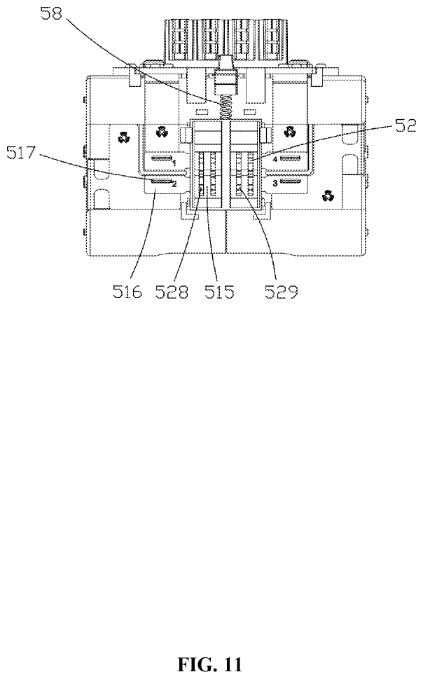

Referring to FIG. 11, when the battery pack 100 outputs the low voltage, the first group of switching elements 528 is electrically connected between the first connecting piece 511 and the second connecting piece 512, the second group of switching elements 529 is electrically connected between the third connecting piece 513 and the fourth connecting piece 514, and the intermediate connecting piece 510 does not play a conductive role. The first positive output terminal 211 and the second positive output terminal 221 are both connected to the total positive output terminal 41, and the first negative output terminal 212 and the second negative output terminal 222 are both connected to the total negative output terminal 42, thereby realizing a parallel connection of the first cell group 21 and the second cell group 22. At this time, the battery pack 100 outputs a low voltage of 20V to the outside.

In the present embodiment, the above first group of switching elements 528 and second group of switching elements 529 each have at least two switching elements 52, so as to achieve better conductive performance.

In the present embodiment, the above first connecting piece 511 is located between the second connecting piece 512 and the intermediate connecting piece 510, the fourth connecting piece 514 is located between the third connecting piece 513 and the intermediate connecting piece 510; and the intermediate connecting piece 510 straddles the first connecting piece 511 and the fourth connecting piece 514, so that when the battery pack 100 outputs the high voltage, the first group of switching elements 528 and the second group of switching elements 529 can be both connected to the intermediate connecting piece 510.

In conjunction with FIG. 9, the above box body 50 at least partially accommodates the connecting pieces 51 and the switching element 52, and the moving element 55 extends outside the box body 50. Further, the box body 50 has a first box shell 53 and a second box shell 54 connected to each other, and the first box shell 53 and the second box shell 54 are fastened and fixed to each other and enclose to form an accommodating space. The accommodating space accommodates the switching element 52 and the connecting pieces 51. Further, the switching element 52 and the connecting pieces 51 are respectively arranged in different box shells. In the present embodiment, the switching element 52 is movably arranged in the first box shell 53, and the connecting pieces 51 are fixedly arranged in the second box shell 54.

In the present embodiment, any one of the above first connecting piece 511, second connecting piece 512, third connecting piece 513, and fourth connecting piece 514 includes a first contact portion 515 accommodated in the box body 50, a second contact portion 516 exposed outside the box body 50, and a connection port 517 penetrating the second contact portion 516, while the intermediate connecting piece 510 is completely accommodated in the box body 50. The switching element 52 is connected to the first contact portion 515, and the total positive output terminal 41, the second positive output terminal 221, the first negative output terminal 212, and the total negative output terminal 42 are connected to respective corresponding connecting pieces via the connection ports 517.

Further, the first contact portion 515 is located in the accommodating space, and the second contact portion 516 is exposed outside the accommodating space.

Further, the above box body 50 is provided with gas holes 541 at a mounting area corresponding to a first contact portion 515 and at a contact portion corresponding to the intermediate connecting piece 510. The gas holes 541 communicate an interior of the box body 50 with an exterior of the box body 50. Since the first contact portion 515 is mounted in the second box shell 54 and generates heat during conduction, the gas holes 541 are opened in the second box shell 54 to effectively dissipate heat from the first contact portion 515.

Referring to FIG. 5, a connection strap 23 is provided between the total positive output terminal 41 and the first connecting piece 511 to achieve conductive connection between the total positive output terminal 41 and the first connecting piece 511, and another connection strap 23 is provided between the total negative output terminal 42 and the fourth connecting piece 514.

In the present embodiment, the moving element 55 includes a base body 551 for mounting the switching element 52, a rod body 552 connected to the base body 551, and a head part 553 connected to the rod body 552. The base body 551 and the head part 553 are located on two sides of the rod body 552. Further, the first box shell 53 has a guide groove 531 for mounting the rod body 552 and a passage 532 penetrating the guide groove 531. The rod body 552 is inserted through the passage 532, and the base body 551 is at least partially accommodated in the first box shell 53.

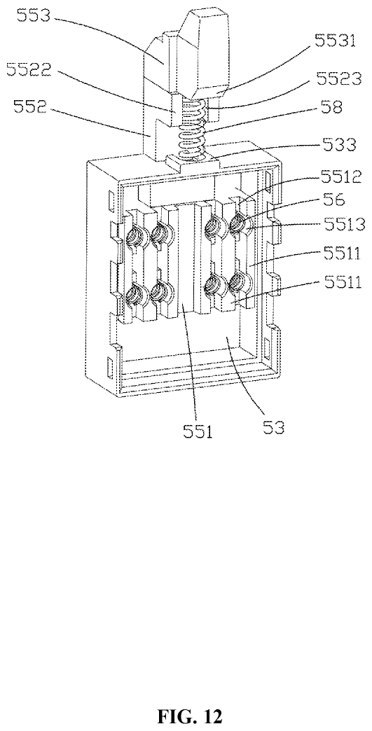

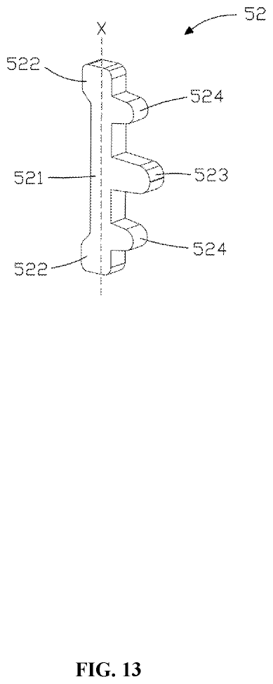

Referring to FIG. 12 and FIG. 13, the switching element 52 includes a main body portion 521, a pair of contacts 522 extending from the main body portion 521 toward the connecting pieces 51, and a guide portion 523 and a pair of wing portions 524 extending from the main body portion 521 toward the base body 551. The pair of contacts 522 are configured to connect any two of the plurality of connecting pieces 51. Correspondingly, the base body 551 includes a pair of clamping arms 5511 arranged at an interval, a movable groove 5512 located between the pair of clamping arms 5511, and a positioning groove 5513 recessed from an end surface of the clamping arm 5511. The main body portion 521 is accommodated in the movable groove 5512.

Further, the voltage transformation assembly 5 includes a second elastic member 56 for biasing the switching element 52. One end of the second elastic member 56 is accommodated in the positioning groove 5513, and the other end of the second elastic member 56 is sleeved on the wing portion 524. Flexible contact between the switching element 52 and the connecting pieces 51 is achieved by the second elastic member 56, which is beneficial to improving conductive performance and prolonging a service life of the voltage transformation assembly.

In the present embodiment, the guide portion 523 is located between the pair of wing portions 524, and extends into the movable groove 5512. A length of the guide portion 523 extending toward the base body 551 is greater than a length of the wing portion 524 extending toward the base body 551, and a thickness of the guide portion 523 is slightly smaller than a width of the movable groove 5512. While the switching element 52 moves freely, the guide portion 523 has a guiding and limiting function.

Referring to FIG. 10, the main body portion 521 has an extension axis X. A projection of the extension axis X on the connecting pieces 51 passes through the first connecting piece 511, the second connecting piece 512, and the intermediate connecting piece 510 at the same time, or passes through the fourth connecting piece 514, the third connecting piece 513, and the intermediate connecting piece 510 at the same time. Further, the first group of switching elements 528 and the second group of switching elements 529 both move along a direction of the extension axis X, and the first group of switching elements 528 and the second group of switching elements 529 are arranged parallel to each other. The movement of the moving element 55 simultaneously drives the first group of switching elements 528 and the second group of switching elements 529 to move.

Referring to FIG. 9 and FIG. 12, the voltage transformation assembly 5 includes a first elastic member 58 biasing the moving element 55. The head part 553 has a first positioning portion 5531 for mounting the first elastic member 58. The first box shell 53 has a second positioning portion 533 protruding from an end surface of the first box shell 53. The first elastic member 58 is connected between the first positioning portion 5531 and the second positioning portion 533. Further, the first elastic member 58 is configured to abut against the moving element 55 so that the battery pack 100 outputs the high voltage when not subjected to an external force. When the head part 553 of the moving element 55 is subjected to an external force and moves, the moving element 55 overcomes an elastic force of the first elastic member 58, and causes the battery pack 100 to switch from the high voltage to the low voltage.

In the present embodiment, the above rod body 552 includes a guide pillar 5522 protruding toward the first elastic member 58 and an avoidance groove 5523 recessed from an end surface of the guide pillar 5522. The first elastic member 58 is inserted through the avoidance groove 5523. The guide pillar 5522 plays a role of guiding and limiting the first elastic member 58.

In the present embodiment, the rod body 552 includes a mounting post 5521 protruding toward the head part 553, and the head part 553 is sleeved on the mounting post 5521. The head part 553 is detachably connected to the rod body 552, and the head part 553 is made of a material more wear-resistant than that of the rod body 552. In an embodiment, the head part 553 is made of a metal material. In an embodiment, the head part 553 is made of an alloy material.

In conjunction with FIG. 1 and FIG. 2, the housing 1 has a through opening 13 opened in the upper housing 11. The moving element 55 is configured to come into contact with an external force via the opening 13, and the external force drives the moving element 55 to move, so as to drive the battery pack 100 to switch between the high voltage and the low voltage. Further, a position of the head part 553 of the moving element 55 corresponds to a position of the opening 13, and the head part 553 extends through the opening 13 and is exposed to the outside of the housing 1 of the battery pack 100 via the opening 13, so that the head part 553 can be subjected to an external force to move.

In the present embodiment, when the battery pack 100 outputs the low voltage, at least a part of the head part 553 of the moving element 55 is retracted into the opening 13.

Referring to FIG. 3, the opening 13 is adjacent to the terminal assembly 4, and the voltage transformation assembly 5 is mounted at an end of the cell assembly 2 close to the terminal assembly 4.

Referring to FIG. 4 to FIG. 7, the above voltage transformation assembly 5 is connected to the cell bracket 24 of the cell assembly 2. The cell bracket 24 includes a first limiting portion 241 and a second limiting portion 242 supporting upper and lower opposite ends of the box body 50 respectively, and a pair of claws 243 fastening the box body 50. The pair of claws 243 are located between the first limiting portion 241 and the second limiting portion 242. The first limiting portion 241 and the second limiting portion 242 are configured to position the box body 50, and the pair of claws 243 are configured to hold the box body 50. During actual assembly, it is only necessary to align two ends of the box body 50 of the voltage transformation assembly 5 with the first limiting portion 241 and the second limiting portion 242, and press firmly into the cell bracket 24. When hooks 2431 of the pair of claws 243 hook the box body 50, the mounting is completed.

Further, the first limiting portion 241 is supported at a corner of the box body 50, and a shape of the first limiting portion 241 matches a shape of the corner of the box body 50. In the present embodiment, the shape of the corner of the box body 50 and the shape of the first limiting portion 241 are arranged in an L shape.

In conjunction with FIG. 10, the cell bracket 24 of the cell assembly 2 further includes two partition plates 244 protruding from an end surface. The two partition plates 244 are each located between two adjacent connecting pieces in an upper-lower direction. Specifically, one partition plate 244 is located between the first connecting piece 511 and the second connecting piece 512 and between the first connecting piece 511 and the second positive output terminal 221, and the other partition plate 244 is located between the fourth connecting piece 514 and the third connecting piece 513 and between the fourth connecting piece 514 and the first negative output terminal 212. The partition plates 244 are configured to separate the first connecting piece 511 from the second positive output terminal 221 and the second connecting piece 512, and to separate the fourth connecting piece 514 from the third connecting piece 513 and the first negative output terminal 212, playing an insulating role.

Referring to FIG. 14 to FIG. 16, the battery pack mounting seat 220 has a first type mounting seat 228 and a second type mounting seat 229 with different structures. When the power tool 200 is assembled with the first type mounting seat 228, the battery pack 100 outputs the high voltage; and when the power tool 200 is assembled with the second type mounting seat 229, the battery pack 100 outputs the low voltage. Further, the power tool 200 assembled with the first type mounting seat 228 is a high-voltage powered tool, and the power tool 200 assembled with the second type mounting seat 229 is a low-voltage powered tool.

Specifically, the battery pack 100 is mounted to the battery pack mounting seat 220 along a front-rear direction. The first type mounting seat 228 has a recessed slot 2280. A position of the slot 2280 corresponds to a position of the opening 13 of the housing 1. When the battery pack 100 is mounted to the first type mounting seat 228, the head part 553 of the moving element 55 of the voltage transformation assembly 5 passes through the opening 13 and extends into the slot 2280. At this time, the voltage transformation assembly 5 does not cause the voltage of the battery pack 100 to switch, and the battery pack 100 outputs the high voltage. The second type mounting seat 229 is provided with an abutting portion 2290 at the position corresponding to the opening 13. When the battery pack 100 is mounted to the second type mounting seat 229, the abutting portion 2290 drives the head part 553 of the moving element 55 to move, and drives the switching element 52 to move, so that the battery pack 100 automatically switches from the high voltage to the low voltage during a process of being plugged into the power tool 200.

It should be noted that the present disclosure does not limit a shape or structure of the abutting portion 2290, as long as when the battery pack 100 is mounted to the power tool 200 assembled with the second type mounting seat 229, the abutting portion 2290 can contact the moving element 55 of the voltage transformation assembly 5 and drive the moving element 55 to move, thereby causing the voltage of the battery pack 100 to switch.

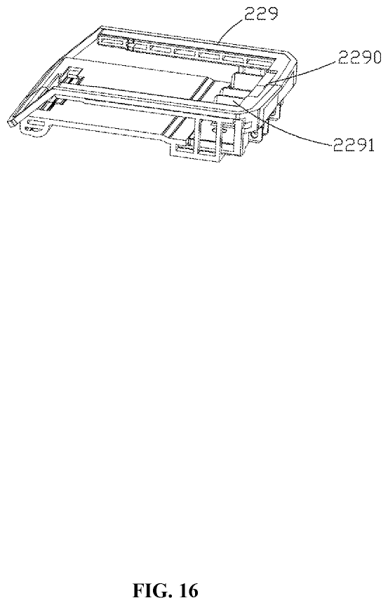

Referring to FIG. 16, in the present embodiment, the abutting portion 2290 is a flat structure on the second type mounting seat 229 at the position corresponding to the opening 13.

By making a differentiated design for the battery pack mounting seat 220 of the power tool 200, the power tool 200 selects a high voltage input or a low voltage input according to the needs of the usage occasion, and further selects the first type mounting seat 228 or the second type mounting seat 229, while the battery pack 100 is not limited and is universally mounted to the first type mounting seat 228 or the second type mounting seat 229, effectively constructing a power tool combination 300 with low cost and good user experience. In addition, when the battery pack 100 is mounted to the power tool 200, the output voltage of the battery pack 100 is automatically switched without additional actions by the user, and the operation is simpler.

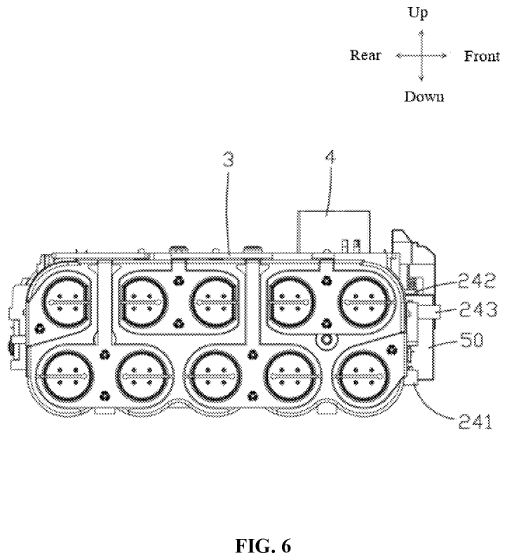

Referring to FIG. 4, FIG. 6, and FIG. 9, the above terminal assembly 4 extends along the front-rear direction and is arranged in a region near the front side, and the battery pack 100 is plugged into the power tool 200 along the front-rear direction. The box body 50 is mounted on a front end side of the cell bracket 24 close to the terminal assembly 4, and the moving element 55 moves along an upper-lower direction. Therefore, a moving direction of the moving element 55 is perpendicular to a plugging direction of the battery pack 100. Further, a plugging direction of the second type mounting seat 229 is also perpendicular to a moving direction of the head part 553.

In conjunction with FIG. 9, the above head part 553 has a guide portion 5531 arranged obliquely with respect to the front-rear direction. When an external force acts on the head part 553 along the front-rear direction, the moving element 55 is driven by the guide portion 5531 to move in the upper-lower direction. Further, when the battery pack 100 is mounted to the power tool 200 assembled with the second type mounting seat 229 along the front-rear direction, the abutting portion 2290 drives the head part 553 to move in the upper-lower direction along the guide portion 5531, thereby causing the battery pack 100 to switch from the high voltage to the low voltage.

In the present embodiment, when the battery pack 100 is mounted to the power tool 200, the voltage transformation assembly 5 preferentially switches the output voltage of the cell assembly 2, and then electrical conduction is achieved between the battery pack 100 and the power tool 200, so that the battery pack 100 supplies power to the power tool 200. This is because, especially when the battery pack 100 is plugged into the power tool 200 assembled with the second type mounting seat 229, the battery pack 100 outputs the high voltage by default. If the electrical conduction between the battery pack 100 and the power tool 200 is achieved first, the high voltage output of the battery pack 100 is bound to cause damage to electronic devices of the power tool 200, and there is a great potential safety hazard in use. In the present disclosure, by first realizing the voltage switching of the voltage transformation assembly 5 and then realizing the electrical conduction between the battery pack 100 and the power tool 200, it is beneficial to improving a service life of the power tool 200 and improving the usage safety of the battery pack 100.

Therefore, when the battery pack 100 is not mounted to the power tool 200 assembled with the second type mounting seat 229, the battery pack 100 outputs the high voltage; and when the battery pack 100 is mounted to the power tool 200 assembled with the second type mounting seat 229, the battery pack 100 outputs the low voltage. Further, the abutting portion 2290 first contacts the moving element 55 and drives the moving element 55 to move, so as to realize the voltage switching of the battery pack 100; then, the tool terminal 2291 contacts the terminal assembly 4 and realizes electrical conduction with the terminal assembly 4, thereby realizing the electrical conduction between the battery pack 100 and the power tool 200, which is beneficial to improving the service life of the power tool 200.

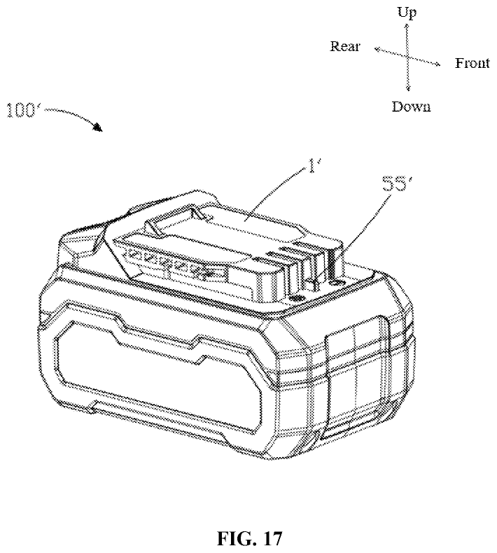

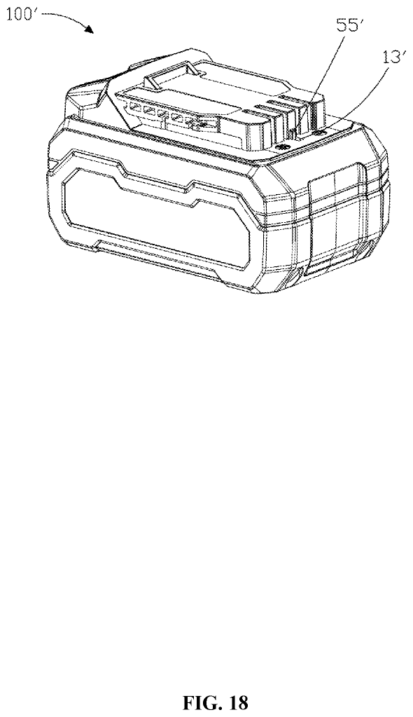

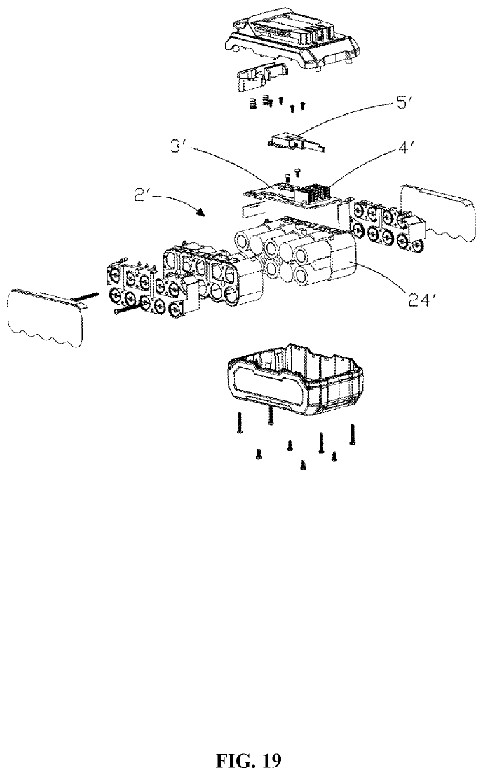

Referring to FIG. 17 to FIG. 24, in a second embodiment of the present disclosure, an overall structure of a battery pack 100′ is substantially the same as the overall structure of the battery pack 100 in the first embodiment.

Further, the battery pack 100′ similarly includes a housing 1′, a cell assembly 2′ mounted in the housing 1′, a control assembly 3′ connected to the cell assembly 2′, a terminal assembly 4′ connected to the control assembly 3′, and a voltage transformation assembly 5′ for switching an output voltage of the cell assembly 2′. The terminal assembly 4′ extends along a front-rear direction, and is located on an upper side of the cell assembly 2′, and the voltage transformation assembly 5′ is arranged on the upper side of the cell assembly 2′. Further, the control assembly 3′ is mounted on the upper side of the cell assembly 2′, and both the terminal assembly 4′ and the voltage transformation assembly 5′ are mounted on an upper side of the control assembly 3′.

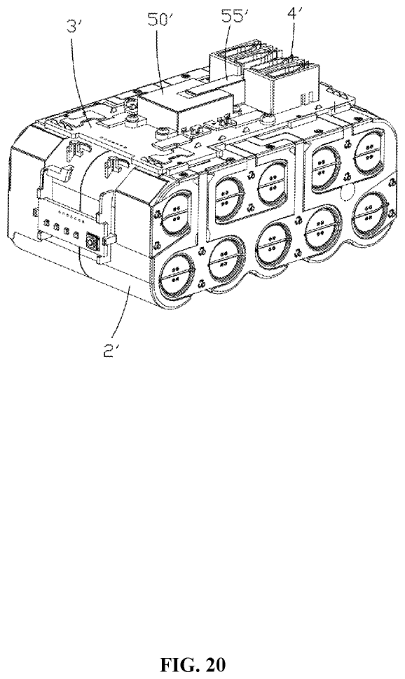

Referring to FIG. 20, the voltage transformation assembly 5′ includes a box body 50′ arranged on the upper side of the cell assembly 2′ and a moving element 55′ movably connected to the box body 50′. An opening 13′ is provided on the housing 1′, and the moving element 55′ extends through the opening 13′ and is exposed to the outside of the housing 1′. In the present embodiment, a moving direction of the moving element 55′ is parallel to a plugging direction of the battery pack 100′, that is, the moving element 55′ moves along the front-rear direction. This is advantageous for triggering of the voltage transformation assembly 5′, because the battery pack 100′ is plugged into the power tool along the front-rear direction, which drives an abutting portion of the battery pack 100′ to move along the front-rear direction, and causes a force of the abutting portion along the front-rear direction to directly drive the moving element 55′ to move along the front-rear direction, and the structure is more stable and reliable.

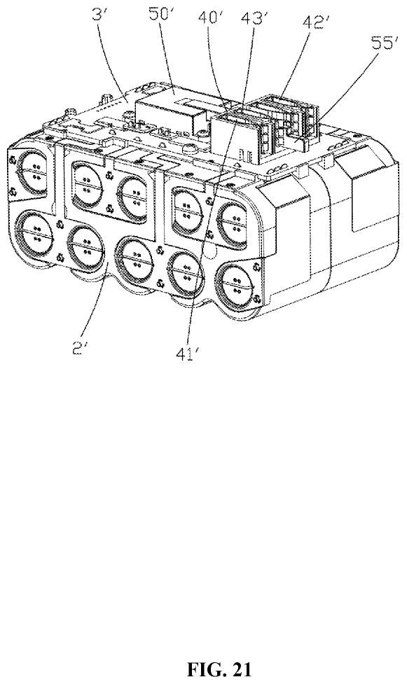

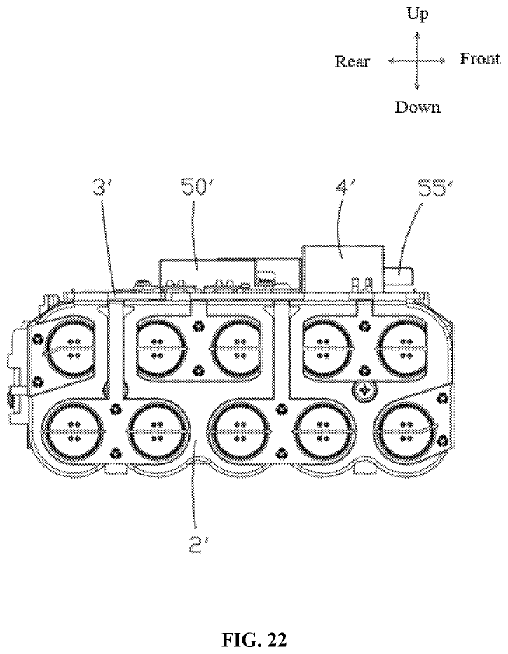

In conjunction with FIG. 21 and FIG. 22, the box body 50′ is located at a rear side of the terminal assembly 4′, and the moving element 55′ extends through the terminal assembly 4′ in the front-rear direction, and extends to a front side of the terminal assembly 4′. Further, a length of the battery pack 100′ in the front-rear direction depends on a length of the cell assembly 2′ in the front-rear direction, and a height of the battery pack 100′ in an upper-lower direction depends on a height of the terminal assembly 4′ in the upper-lower direction, especially a top height of the terminal assembly 4′. Therefore, configuring the voltage transformation assembly 5′ to be located between a front end and a rear end of the cell assembly 2′ in the front-rear direction, and configuring the upper side of the voltage transformation assembly 5′ not to be higher than the upper side of the terminal assembly 4′, is beneficial to miniaturization and compactness of the battery pack 100′.

In the present embodiment, the upper sides of the box body 50′ and the moving element 55′ are not higher than the upper side of the terminal assembly 4′. The box body 50′ is located, in the front-rear direction, between the rear end of the cell assembly 2′ and the rear end of the terminal assembly 4′, and the front side of the moving element 55′ does not exceed the front side of the cell assembly 2′.

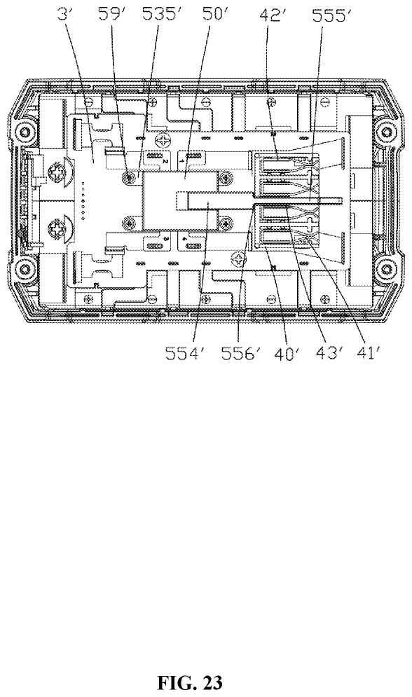

Referring to FIG. 23, projections of the box body 50′ and the terminal assembly 4′ on the control assembly 3′ are within a projection range of the control assembly 3′, so as to further realize the miniaturization and compactness of the battery pack 100′.

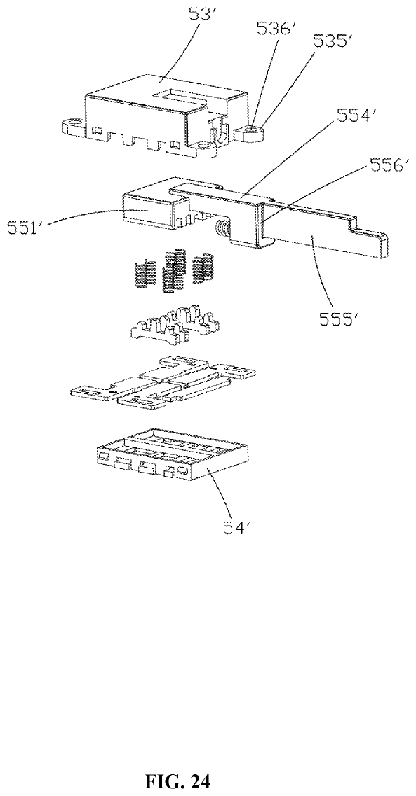

In conjunction with FIG. 21 and FIG. 24, the terminal assembly 4′ includes a terminal block 40′, a plurality of output terminals accommodated in the terminal block 40′, and a passage 43′ penetrating the terminal block 40′ along the front-rear direction. The moving element 55′ is inserted through the passage 43′, thereby facilitating normal movement of the moving element 55′. Further, the passage 43′ is formed by removing material from the terminal block 40′.

In the present embodiment, the moving element 55′ includes a base body 551′ connected to the box body 50′, a first rod body 554′ connected to the base body 551′, a second rod body 555′ connected to the first rod body 554′, and a contact surface 556′ formed at a joint position of the first rod body 554′ and the second rod body 555′. The second rod body 555′ is inserted through the passage 43′, and the first rod body 554′ and the contact surface 556′ are located at the rear side of the terminal block 40′.

In the present embodiment, the plurality of output terminals include a total positive output terminal 41′ and a total negative output terminal 42′ for outputting the power of the cell assembly 2′ to the outside. The second rod body 555′ is made of an insulating material, and the total positive output terminal 41′ and the total negative output terminal 42′ are located on two sides of the second rod body 555′, so that the battery pack 100′ has good insulation performance.

In conjunction with FIG. 23 and FIG. 24, the box body 50′ has a first box shell 53′ and a second box shell 54′ connected to each other. The first box shell 53′ includes a connection seat 535′ mounted to the control assembly 3′ and a mounting hole 536′ penetrating the connection seat 535′. A screw 59′ sequentially passes through the mounting hole 536′, the control assembly 3′, and the cell assembly 2′, thereby better fixing the box body 50′.

It should be note that: the above-mentioned embodiments are only specific implementations of the present disclosure, and used to illustrate the technical solutions of the present disclosure, rather than limiting the present disclosure. The protection scope of the present disclosure is not limited thereto. Although the present disclosure has been described in detail with reference to the foregoing embodiments, those of ordinary skill in the art should understand that: any person skilled in the art, within the technical scope disclosed by the present disclosure, can still modify or easily think of changes to the technical solutions described in the foregoing embodiments, or make equivalent replacements for some of the technical features therein; and these modifications, changes, or replacements do not make the essence of the corresponding technical solutions deviate from the spirit and scope of the technical solutions of the embodiments of the present disclosure, and should all be covered within the protection scope of the present disclosure. Therefore, the protection scope of the present disclosure shall be subject to the protection scope of the claims.

What is claimed is:

1. A battery pack, comprising:
a housing;
a cell assembly, mounted in the housing and including a first cell group and a second cell group connected to each other, wherein the first cell group has a first positive output terminal and a first negative output terminal, and the second cell group has a second positive output terminal and a second negative output terminal;
a control assembly, connected to the cell assembly;
a terminal assembly, connected to the control assembly and including a total positive output terminal and a total negative output terminal configured to output power of the cell assembly to outside; and
a voltage transformation assembly, configured to switch an output voltage of the cell assembly and including:
a plurality of connecting pieces connected to the total positive output terminal, the second positive output terminal, the first negative output terminal and the total negative output terminal; and
a switching element, movably arranged relative to the plurality of connecting pieces and configured to move to different positions to change an electrical connection relationship among the plurality of connecting pieces so that the battery pack switches its output voltage between a high voltage and a low voltage, a voltage value of the high voltage being larger than a voltage value of the low voltage;
wherein when the battery pack outputs the high voltage, the first cell group and the second cell group are connected in series, and when the battery pack outputs the low voltage, the first cell group and the second cell group are connected in parallel.

2. The battery pack according to claim 1, wherein the plurality of connecting pieces include:
a first connecting piece, connected to the total positive output terminal;
a second connecting piece, connected to the second positive output terminal;
a third connecting piece, connected to the first negative output terminal;
a fourth connecting piece, connected to the total negative output terminal; and
an intermediate connecting piece;
wherein when the battery pack outputs the high voltage, the second connecting piece is electrically connected to the third connecting piece via the intermediate connecting piece, and when the battery pack outputs the low voltage, the first connecting piece is electrically connected to the second connecting piece, and the third connecting piece is electrically connected to the fourth connecting piece.

3. The battery pack according to claim 2, wherein the voltage transformation assembly further includes:
a box body, wherein the plurality of connecting pieces are all fixed to the box body; and
a moving element, movably connected to the box body and connected to the switching element.

4. The battery pack according to claim 3, wherein the moving element includes:
a base body, configured to mount the switching element;
a rod body, connected to the base body; and
a head part, connected to the rod body, wherein the base body and the head part are located on two sides of the rod body, the housing has a through opening, and the head part is exposed outside the battery pack via the opening.

5. The battery pack according to claim 4, wherein the box body has a first box shell and a second box shell connected to each other, the first box shell has a guide groove configured to mount the rod body and a passage penetrating the guide groove, and the rod body is inserted through the passage.

6. The battery pack according to claim 5, wherein the voltage transformation assembly further includes:
a first elastic member, biasing the moving element, wherein the head part has a first positioning portion for mounting the first elastic member, the first box shell has a second positioning portion protruding from an end surface, and the first elastic member is connected between the first positioning portion and the second positioning portion.

7. The battery pack according to claim 6, wherein the rod body includes:
a guide pillar, protruding toward the first elastic member; and
an avoidance groove, recessed from an end surface of the guide pillar, wherein the first elastic member is inserted through the avoidance groove.

8. The battery pack according to claim 4, wherein the switching element includes:
a main body portion; and
a pair of contacts, extending from the main body portion toward the plurality of connecting pieces, and configured to connect any two of the plurality of connecting pieces.

9. The battery pack according to claim 8, wherein the base body includes:
a pair of clamping arms, arranged at an interval; and
a movable groove, located between the pair of clamping arms, wherein the main body portion is accommodated in the movable groove.

10. The battery pack according to claim 9, wherein the base body further includes:
a positioning groove, recessed from an end surface of a respective clamping arm;
wherein the switching element further includes a wing portion extending from the main body portion toward the base body; and
wherein the voltage transformation assembly further includes a second elastic member biasing the switching element, one end of the second elastic member is accommodated in the positioning groove, and another end of the second elastic member is sleeved on the wing portion.

11. The battery pack according to claim 10, wherein the switching element further includes:
a guide portion, extending from the main body portion toward the base body, located between a pair of wing portions, and extending into the movable groove, wherein a length of the guide portion extending toward the base body is greater than a length of each of the pair of wing portions extending toward the base body.

12. The battery pack according to claim 3, wherein each of the first connecting piece, the second connecting piece, the third connecting piece, and the fourth connecting piece includes a first contact portion accommodated in the box body, a second contact portion exposed outside the box body, and a connection port penetrating the second contact portion, the switching element is connected to the first contact portion, and the total positive output terminal, the second positive output terminal, the first negative output terminal, and the total negative output terminal are respectively connected to the plurality of connecting pieces via connection ports.

13. The battery pack according to claim 12, wherein the box body is provided with a gas hole at a mounting area corresponding to the first contact portion, and the gas hole communicates an interior of the box body with an exterior of the box body.

14. The battery pack according to claim 12, wherein the first connecting piece is located between the second connecting piece and the intermediate connecting piece, the fourth connecting piece is located between the third connecting piece and the intermediate connecting piece, and the intermediate connecting piece straddles the first connecting piece and the fourth connecting piece.

15. The battery pack according to claim 14, wherein the main body portion has an extension axis, and a projection of the extension axis on the plurality of connecting pieces simultaneously passes through the first connecting piece, the second connecting piece, and the intermediate connecting piece, or simultaneously passes through the fourth connecting piece, the third connecting piece, and the intermediate connecting piece.

16. The battery pack according to claim 8, wherein a plurality of switching elements are provided, and include a first group of switching elements configured to change a connection relationship among the first connecting piece, the second connecting piece, and the intermediate connecting piece, and a second group of switching elements configured to change a connection relationship among the fourth connecting piece, the third connecting piece, and the intermediate connecting piece, and each of the first group of switching elements and the second group of switching elements has at least two switching elements.

17. The battery pack according to claim 1, wherein the cell assembly further includes:
a cell bracket, configured to mount the first cell group and the second cell group, connected to the voltage transformation assembly, and including:
a first limiting portion and a second limiting portion, respectively supporting two opposing ends of a box body of the voltage transformation assembly; and
a pair of claws, configured to fasten the box body and located between the first limiting portion and the second limiting portion.

18. The battery pack according to claim 2, wherein the cell assembly has a cell bracket including:
a partition plate, protruding from an end surface of the cell bracket, wherein at least a part of the partition plate is located between the first connecting piece and the second connecting piece, and at least another part of the partition plate is located between the fourth connecting piece and the third connecting piece.

19. A power tool combination, comprising:
a power tool, including a casing, a drive assembly mounted in the casing, and an output head connected to the drive assembly; and
the battery pack according to claim 1, wherein the battery pack is connected to the power tool and configured to provide energy for the drive assembly;
wherein the casing includes a battery pack mounting seat configured to mount the battery pack and having a first type mounting seat and a second type mounting seat with different structures; and
wherein the battery pack is configured to output the high voltage when the power tool is assembled with the first type mounting seat, and to output the low voltage when the power tool is assembled with the second type mounting seat.

20. The power tool combination according to claim 19, wherein the first type mounting seat has a recessed slot, a position of the slot corresponds to a position of an opening of the housing, and when the battery pack is mounted to the first type mounting seat, a moving element of the voltage transformation assembly passes through the opening and extends into the slot; and
wherein the second type mounting seat is provided with an abutting portion at the position corresponding to the opening, and when the battery pack is mounted to the second type mounting seat, the abutting portion drives the moving element to move so that the battery pack switches from the high voltage to the low voltage.
